(19) United States
(12) Patent Application Publication
(10) Pub. No.: US 2026/0276772 A1
(43) Pub. Date: Sep. 17, 2026

(54) SYSTEMS, METHODS AND APPARATUS FOR DETERMINING OBJECT POSITION

(71) Applicant: SKYRORA LIMITED, Glasgow (GB)

(72) Inventors: Mykyta Spirin, Cumbernauld (GB); Oleksandr Moroz, Cumbernauld (GB)

(21) Appl. No.: 19/107,508

(22) PCT Filed: Aug. 29, 2023
(86) PCT No.: PCT/GB2023/052222

§ 371 Date: Feb. 27, 2025

(30) Foreign Application Priority Data
Aug. 29, 2022 (GB) 2212499.4

(51) Int. Cl. G01S 3/46; G01S 3/28; G01S 5/02; G01S 5/04

(52) U.S. Cl. CPC G01S 3/46; G01S 3/28; G01S 5/02213; G01S 5/04

(57) ABSTRACT

A relatively simple and cost-effective way of determining the position of an object, such as a launch vehicle, without the need for expensive radar installations or GPS receivers. A transmitter is mounted on or in the object and the signal transmitted thereby from the object is detected by two or more object trackers on the ground. The object trackers determine the azimuth and elevation angles to the object relative to the object trackers by automatically pointing the object trackers at the object, tracking the object as it moves, and recording the azimuth and elevation angles at which the object trackers are pointed. Based on the known coordinates of the object trackers, which may themselves be moved or moving, the position of the object can be determined from the determined azimuth and elevation angles. There is also described a way of achieving the automatic tracking, by minimizing the phase difference between the signal detected by closely spaced pairs of antennas.

The present invention relates to the field of determining the position of objects including airborne objects such as aircraft, drones and in particular launch vehicles. More specifically, the present invention concerns improvements to systems, methods and apparatus for determining the position of objects that eliminates the need for GPS- and radar-based range systems.

### BACKGROUND TO THE INVENTION

Within the burgeoning small satellite market there is a growing demand for launch vehicles to place payloads into orbit and provide access to space for missions including Earth observation, communication and navigation, amongst many more. The Applicant has recently performed a full ground test of its unique 70 kN rocket engine, marking a key milestone in the developments of its proprietary XL orbital vehicle which will use the rocket engine in its first and second stages. However, propulsion is only one consideration in the provision of cost-effective and responsive access to space; the small space industry requires innovation in a wide range of technical fields and areas of technology to lower the barrier to entry for commercial spaceflight activities. This includes making it easier to comply with stringent government regulations.

One such problem is how to determine the position of launch vehicles without reliance on GPS or RADAR systems, which require significant technological and financial investment which is typically beyond the reach of those operating in the small space industry (or those who wish to enter the market), and which may also carry a significant regulatory burden.

It is possible to characterise existing solutions for launch vehicle position determination (or tracking; these terms may be used interchangeably) as internal or external solutions.

Internal solutions for determining the coordinates of a launch vehicle typically make use of GPS receivers located on board the launch vehicle and transmission of the position information obtained from those GPS receivers over a radio channel to a ground-based control station, for example. The disadvantage of such methods is that they require the use of expensive GPS-receivers which can operate at the speeds and accelerations at which the launch vehicles move; ordinary “household” GPS receivers are entirely unsuitable for these purposes. At the same time, even the use of such receivers does not guarantee obtaining the exact coordinates of the launch vehicle on the ground, since it is also highly reliant upon having avionic systems that will not fail in the extreme conditions to which the launch vehicle is subjected.

External methods for determining the coordinates of a launch vehicle typically use radar to track in active (i.e., with a transceiver on board the launch vehicle) or passive methods. The advantage of such external methods is that they can be independent of, and hence not reliant on, the on-board avionics. In theory, it is possible to determine the coordinates of a launch vehicle regardless of the condition of the equipment on board; this is important as if on-board telemetry fails a launch vehicle may otherwise be very difficult to track. However, the accuracy of such external methods is inversely proportional with distance to the launch vehicle. Furthermore, launch vehicle radar tracking requires ultra-directional antennas as used in radar installations, which are large and expensive and require complex (read expensive and high maintenance) rotary support mechanisms.

Accordingly, it is an object of aspects of the present invention to provide methods and apparatus for determining the position of an object, which may be an airborne object such as a launch vehicle, that obviates and/or mitigates one or more disadvantages of known/prior methods.

Further aims and objects of the invention will become apparent from reading the following description.

### SUMMARY OF THE INVENTION

According to a first aspect of the invention, there is provided a system for determining the position of an object, the system comprising:
a transmitter for locating on or in the object and configured to transmit a signal;
a first object tracker configured to detect the signal and determine a first azimuth angle and a first elevation angle to the transmitter;
a second object tracker configured to detect the signal and determine a second azimuth angle and a second elevation angle to the transmitter;
wherein the system is configured to determine the position of the transmitter based on the first and second azimuth angles, the first and second elevation angles, and the respective positions of the object trackers.

The position of the transmitter is inevitably also the position of the object; the term “position of the transmitter” is preferred as the object itself does not form part of the system. However, the term “position of the transmitter” and “position of the object” may be used interchangeably, and the Applicant reserves the right to use such language or terminology (i.e., “object” in place of “transmitter”) if it becomes necessary or appropriate.

Preferably, one or more of the object trackers are fixed in position. Alternatively, or additionally, one or more of the object trackers are moveable. For example, one or more of the object trackers may be mounted on a vehicle. In any case, the positions or coordinates of each of the object trackers may be expressed as (Bx,Lx,hx) where B is the geodetic latitude, L is the longitude, h is the geodetic height, and x is an integer identifying the relevant object tracker.

The invention is not limited to a system comprising two object trackers; accordingly, the system optionally comprises a plurality of object trackers exceeding two. Preferably, each object tracker of the plurality may be configured to detect the signal and determine a respective azimuth angle and a respective elevation angle to the transmitter.

Optionally, the plurality of object trackers is arranged in or otherwise forms an array or network of object trackers.

Optionally, the system is configured to determine the position of the transmitter based on azimuth angles, elevation angles, and respective positions of two object trackers selected from the plurality of object trackers. Put another way, the first and second object trackers may be any two object trackers selected from the plurality of object trackers.

Preferably, an or each object tracker is configured to track the azimuth angle and elevation angle to the transmitter as the object (and hence the transmitter) moves. Preferably, an or each object tracker is configured to track the azimuth angle and elevation angle to the transmitter by automatically pointing the object tracker in the direction of the transmitter. Optionally, an or each object tracker comprises a pan and tilt unit to control the azimuth angle and elevation angle, or direction, in which the object tracker points.

Optionally, an or each object tracker comprises a plurality of antennas. Preferably, an or each object tracker is configured to automatically point the antennas in the direction of the transmitter. Preferably, an or each object tracker comprises at least two pairs of antennas, which may be arranged in orthogonal planes. The orthogonal planes preferably correspond to the azimuthal and elevation planes.

Optionally, an or each object tracker is configured to determine a phase difference between the signal as received at the antennas of each pair of antennas. The phase difference corresponds to an angular offset between the orientation of the antennas and the direction (in the respective plane) of the transmitter. Preferably, an or each object tracker is configured to zero or at least minimise the phase difference so as to automatically point the antennas and hence the object tracker in the direction of the transmitter.

Alternatively, or additionally, an or each object tracker is configured to determine a relative direction to the transmitter based on a phase difference between two antennas (without necessarily changing the direction in which the object tracker is pointing). Alternatively, or additionally, an or each object tracker is configured to determine a relative direction to the transmitter based on an amplitude difference between two antennas (again, without necessarily changing the direction in which the object tracker is pointing).

Preferably, an or each object tracker comprises an azimuth motor and an elevation motor to control the azimuth angle and the elevation angle of the antennas. Preferably, an or each object tracker comprises an azimuth encoder and an elevation encoder to measure the azimuth angle and the elevation angle of the antennas. By azimuth angle and elevation angle of the antennas we mean the direction in which the antenna or the object tracker is pointing.

Preferably, the transmitter is configured to transmit an omnidirectional signal.

Optionally, the transmitter is an S-band transmitter. Optionally, the transmitter transmits in the 2-4 GHz frequency range. Preferably, the transmitter is an SDR transmitter. Optionally, the transmitter is a dedicated transmitter for the system. Alternatively, the transmitter serves a primary purpose which is not for determining the position of the object. For example, the transmitter may transmit data or otherwise serve another purpose within the object. The data may include telemetry data.

Optionally, the system comprises one or more processors which receive the first and second azimuth angles, the first and second elevation angles, and the respective positions of the object trackers, and determine the position of the transmitter. Preferably, one or more processors are associated with one of the object trackers, or may be located proximate to one of the object trackers.

Optionally, the system comprises communication means. Optionally, the communication means is configured to transmit the first and second azimuth angles and the first and second elevation angles, and optionally the respective positions of the object trackers,

In a preferred embodiment of the first aspect of the invention, each object tracker comprises two pairs of antennas and the object trackers are configured to point the pairs of antennas at the transmitter by minimising the phase difference between the detected signals, and a corresponding pair of encoders to determine the azimuth and elevation angles at which the pairs of antennas are pointed.

According to a second aspect of the invention there is provided a method of determining the position of an object, the method comprising:
detecting a signal from the object at a first position and determining a first azimuth angle and a first elevation angle to the object;
detecting the signal from the object at a second position and determining a second azimuth angle and a second elevation angle to the object; and
determining the position of the object based on the first and second azimuth angles, the first and second elevation angles, and the first and second positions.

Preferably, the method comprises providing first and second object trackers to detect the signal at the first and second positions.

Preferably, the method comprises fixing the object trackers in position. Alternatively, the object trackers are moveable, and the method comprises moving one or more of the object trackers. In any case, the positions or coordinates of each of the object trackers may be expressed as (Bx, Lx,hx) where B is the geodetic latitude, L is the longitude, h is the geodetic height, and x is an integer identifying the relevant object tracker.

The invention is not limited to detecting the signal at two positions; accordingly, the method may comprise detecting the signal from the object at one or more further positions and determining corresponding one or more further azimuth and elevation angles to the object; and determining the position of the object based on at least two of the first, second and one or more further azimuth and elevation angles, and the corresponding positions.

Preferably, the method comprises tracking the azimuth angle and elevation angle to the transmitter at each position as the object moves. Preferably, tracking the azimuth angle and elevation angle to the transmitter at each position comprises automatically pointing a respective object tracker in the direction of the object.

Optionally, an or each object tracker comprises a plurality of antennas and the method comprises automatically pointing the antennas in the direction of the object. Preferably, the method comprises determining a phase difference between the signal received at a first antenna and the signal received at a second antenna. Preferably, the method comprises changing the direction in which the antennas are pointing to zero or at least minimise the phase difference so as to automatically point the antennas in the direction of the object.

Preferably, the plurality of antennas are arranged in pairs. Preferably, a first pair of antennas are arranged in or correspond to an azimuthal or horizontal plane, and a second pair of antennas are arranged in or correspond to an elevation or vertical plane.

Alternatively, or additionally, the method comprises determining a relative direction to the transmitter based on a phase difference between two antennas (without necessarily changing the direction in which the object tracker is pointing). Alternatively, or additionally, the method comprises determining a relative direction to the transmitter based on an amplitude difference between two antennas (again, without necessarily changing the direction in which the object tracker is pointing).

Preferably, the method comprises controlling the azimuth angle and the elevation angle of the antennas. Preferably, the method comprises measuring the azimuth angle and the elevation angle of the antennas. By azimuth angle and elevation angle of the antennas we mean the direction in which the antennas are pointing.

Optionally, the method comprises providing a transmitter configured to transmit the signal on or in the object. Alternatively, the signal originates from an existing component of the object.

Preferably, the transmitter (or the existing component) transmits an omnidirectional signal.

Optionally, the method comprises transmitting a signal in the S-band. Optionally, the method comprises transmitting a signal in the 2-4 GHz frequency range. Optionally, the method comprises transmitting data, which may include telemetry data, and the data signal is detected.

Optionally, the method comprises transmitting or otherwise communicating the first and second azimuth angles and the first and second elevation angles, and optionally the respective positions of the object trackers.

In a preferred embodiment of the first aspect of the invention, the method comprises automatically pointing two pairs of antennas at the object by minimising the phase difference between the signal originating from the object as detected at each antenna, and determining the azimuth and elevation angles at which the pairs of antennas are pointed using corresponding azimuth and elevation encoders.

Embodiments of the second aspect of the invention may comprise features of or corresponding to the preferred or optional features of the first aspect of the invention or vice versa.

According to a third aspect of the invention there is provided a method of calibrating a system for determining the position of an object, the method comprising:
locating a transmitter on an aerial vehicle and determining the position of the aerial vehicle using a first system for determining the position of an object not according to the first aspect;
providing a second system for determining the position of an object according to the first aspect and determining the position of the aerial vehicle using the second system; and
calibrating the second system based on a comparison between the position of the aerial vehicle determined by the first system and the position of the aerial vehicle determined by the second system.

Preferably, the first system comprises GPS. Alternatively, the first system comprises radar.

Optionally, the aerial vehicle is unmanned. Optionally, the aerial vehicle is a drone.

Preferably, the method comprises moving the aerial vehicle within a test area and determining first and second sequences of positions of the aerial vehicle using the first and second systems, respectively, and calibrating the second system based on a comparison between the first and second sequences.

Embodiments of the third aspect of the invention may comprise features of or corresponding to the preferred or optional features of the first or second aspects of the invention or vice versa. In particular, determining the position of the aerial vehicle using the second system may comprises steps corresponding to the preferred or optional steps of the second aspect.

As noted above, the term “position of the transmitter” and “position of the object” may be used interchangeably, particularly if the object forms part of the system. Accordingly, in a further aspect of the invention there is provided a system comprising the system of the first aspect and an object which comprises the transmitter, wherein the system determines the position of the object by determining the position of the transmitter.

Optionally, the transmitter is an existing or standard component of the object. In other words, the system can make use of a transmitter which serves a primary purpose which is not for object tracking, for example data transmission. Alternatively, the transmitter is a dedicated transmitter which transmits a signal solely for the purpose of determining the position of the object.

Embodiments of this aspect may comprise features of or corresponding to the preferred or optional features of the first, second or third aspects of the invention or vice versa. In particular, this aspect may comprise any of the preferred or optional features of the first aspect.

Although not so limited, the object in any of the preceding aspects of the invention is preferably a launch vehicle, and most preferably is a launch vehicle for carrying a payload such as a spacecraft or a satellite from the surface of the Earth to space.

### BRIEF DESCRIPTION OF THE DRAWINGS

Aspects and advantages of the present invention will become apparent upon reading the following detailed description and upon reference to the following drawings (like reference numerals referring to like features) in which:

FIG. 1 is a schematic representation of an object tracking system;

FIG. 2 shows a spherical triangle which is helpful to understand how the position of the object is determined from azimuth and elevation data obtained from the object trackers of the object tracking system shown in FIG. 1;

FIG. 3 is a schematic representation of an object tracker of the object tracking system shown in FIG. 1;

FIG. 4 is a schematic representation of a pan and tilt unit of the object tracker shown in FIG. 2;

FIG. 5 illustrates how the object tracker shown in FIGS. 1 and 3 automatically track the object;

FIG. 6 is a schematic representation showing further detail of an object tracking system during calibration.

### DETAILED DESCRIPTION OF PREFERRED EMBODIMENTS

As discussed in the background to the invention above, existing launch vehicle tracking methods and apparatus rely on on-board avionics, GPS and/or radar tracking systems which have various disadvantages which limit their utility or otherwise prevent those operating in the small space industry from adoption. The present invention is intended to provide methods and apparatus for tracking launch vehicles which are within their financial reach and technical capabilities, although it will be recognised that the methods and apparatus described herein may find utility in tracking other airborne or otherwise moving (or indeed stationary) objects.

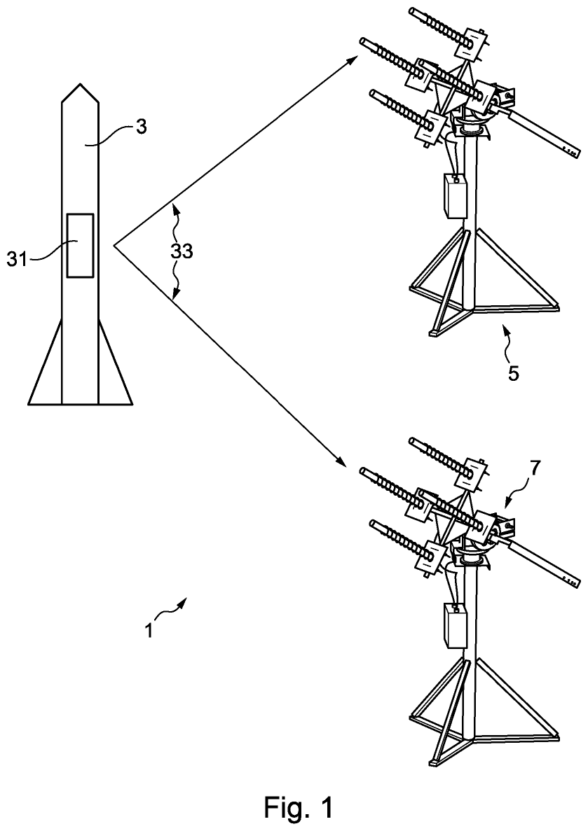

An embodiment of the present invention is illustrated schematically in FIG. 1 and overcomes various problems with the prior art. An object tracking system 1 which is capable of determining the position or coordinates of an object 3 makes use of a transmitter 31 which is located in (or on) the object 3 and transmits a tracking signal 33, and two object trackers 5,7 which detect the tracking signal 33 and enable the position of the object 3 to be determined as described in more detail below. Note that while the signal 33 is denoted schematically by line arrows the signal is omni-directional.

In this embodiment, the transmitter 31 is a simple S-band transmitter, transmitting in the 2-4 GHz frequency range. A small SDR (software defined radio) transmitter is ideal for the purpose and such devices are already in common use in aerospace and small satellite applications, so regulatory compliance will not be an issue. It will of course be understood that any kind of transmitter transmitting at any useful frequency may be employed, though the S-band is advantageous for low atmospheric and environmental interference.

While the system 1 makes use of two object trackers it will be understood that any plurality of object trackers may be employed in the system but two provides an example which is convenient to explain. It is also foreseen that in the event of a plurality exceeding two object trackers, the position may best be determined by the two most proximate object trackers, but an array or network of multiple object trackers disposed over a wide area may provide redundancy as well as continuous tracking if the object 3 moved out of range of one or more object trackers and into the range of other object trackers.

The object trackers 5,7 are spaced apart and hence detect the signal 31 originating from the S-band transmitter 33 housed within the object 3. The object trackers 5,7 automatically track the position of the object 3 as it moves (as described in further detail below) such that the azimuths and elevation angles of the object 3 relative to each of the object trackers 5.7 is continuously measured or determined. Assuming the position of the object trackers 5,7 is fixed the measured or determined azimuth and elevation angles can be used to determine the coordinates of the object 3.

The positions of the object trackers 5,7 can be expressed by the geodetic coordinates (B1,L1,h1) and (B2,L2,h2) respectively (1 denoting the first object tracker and 2 denoting the second object tracker), and the respective azimuths and elevation angles can be expressed as (Az1,El1) and (Az2,El2). The geodetic coordinates of the object 3 which we wish to determine can be expressed as (B3,L3,h3).

Using spherical geometry, the distance d between the object trackers 5,7 can be determined according to the haversine formula:

$$hav ( \frac{( i}{R} ) = hav ( B 2 - B 1 ) + cos ( B 1 ) cos ( B 2 ) hav ( L 2 - L 1 ) \qquad [ 1 ]$$

where d is the length of the orthodrome on the sphere and R is the radius of the sphere. Considering that:

$$haversin ( \frac{d}{R} ) = {sin}^{2} ( \text{?} )$$

formula [1] may be rewritten with respect to d as follows:

$$d = \text{?} ( \sqrt{{sin}^{2} ( \frac{B 2 - B 1}{2} ) + cos ( B 1 ) \text{?} ( B 2 ) \text{?} ( \frac{L 2 - L 1}{2} ) )} \qquad [ 2 ]$$

To determine the azimuths between the object trackers 5,7:

$$Az 12 = \{ \begin{matrix}a cos ( ( sin ( B 2 ) - sin ( B 1 ) \text{?} ( \frac{d}{R} ) ) / ( sin ( \frac{d}{R} ) \text{?} ( B 1 ) ) ) & if sin ( L 2 - L 1 ) > 0 \\ , & \\ \text{?} - a cos ( ( sin ( B 2 ) - sin ( B 1 ) \text{?} ( \frac{d}{R} ) ) / ( sin ( \frac{d}{R} ) \text{?} ( B 1 ) ) ) & otherwise\end{matrix} \} \qquad [ 3 ]$$

$$Az 21 = \{ \begin{matrix}2 \cdot π - a cos ( ( sin ( B 1 ) - sin ( B 2 ) \cdot cos ( \frac{d}{R} ) ) / ( sin ( \frac{d}{R} ) \cdot cos ( B 2 ) ) ) & if sin ( L 2 - L 1 ) > 0 \\ , & \\ a cos ( ( sin ( B 1 ) - sin ( B 2 ) \cdot cos ( \frac{d}{R} ) ) / ( sin ( \frac{d}{R} ) \cdot cos ( B 2 ) ) ) & otherwise\end{matrix} \} \qquad [ 4 ]$$

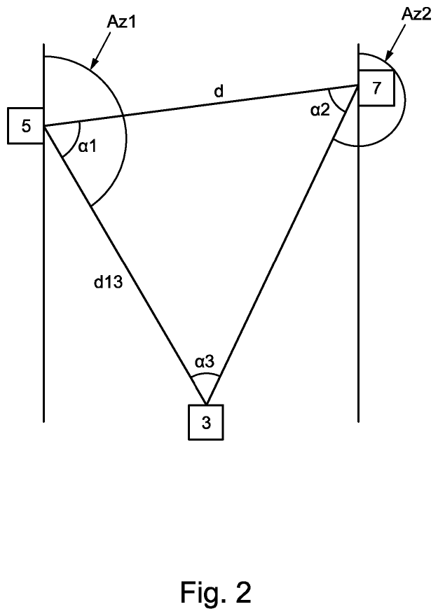

With reference to FIG. 2, which shows a spherical triangle showing the mutual position of the object trackers 5,7 and the object 3, we wish to determine the angles α1, α2 as follows:

$$α 1 = Az 1 - Az 12 , \qquad ( 5 )$$

$$α 2 = Az 21 - Az 2. \qquad ( 6 )$$

Using the second spherical cosine theorem, the angle α3 is determined by:

$$α 3 = a cos ( - cos ( α 1 ) \text{?} ( α 2 ) + sin ( α 1 ) \text{?} ( α 2 ) \text{?} ( \frac{d}{R} ) ) \qquad [ 7 ]$$

From the spherical theorem of sines, the range from object tracker 5 (located at B1,L1,h1) is determined by:

$$d 13 = \frac{sin ( a 2 ) \text{?} ( \frac{d}{R} )}{sin ( α 3 )} \qquad [ 8 ]$$

Or alternatively by:

$$d 13 = a tan 2 ( sin ( d / R ) \cdot sin ( α1 ) \cdot sin ( α2 ) , cos ( α2 ) + cos ( α1 ) \cdot cos ( α3 ) ) \qquad [ 9 ]$$

Knowing the coordinates and azimuth of the object tracker 5 and the distance to the object 3, the geodetic latitude and longitude of the object 3 is determined by:

$$B 3 = a sin ( sin ( B 1 ) \cdot cos ( d 13 ) + cos ( B 1 ) \cdot sin ( d 13 ) \cdot cos ( Az 1 ) ) \qquad [ 10 ]$$

$$L 3 = L 1 + a tan 2 ( sin ( Az 1 ) \cdot sin ( d 13 ) \cdot cos ( B 1 ) , cos ( d 13 ) - sin ( B 1 ) \cdot sin ( B 3 ) ) \qquad [ 11 ]$$

The geodetic height of the object 3 is determined from the first and/or the second object tracker 5,7 by:

$$h 3 \_ 1 = d 13 \cdot R \cdot tan ( El 1 ) + h 1 \qquad [ 12 ]$$

$$h 3 \_ 2 = \text{?} ( \sqrt{{sin}^{2} ( \frac{B 3 - B 2}{2} ) + cos ( B 2 ) \text{?} ( B 3 ) \text{?} ( \frac{L 3 - L 2}{2} ) )} \text{?} ( El 2 ) + h 2 \qquad [ 13 ]$$

Following the above the coordinates (B3,L3,h3) of the object 3 is determined.

Note in the example above the object trackers 5,7 are assumed to be fixed in position. It is foreseen that the object trackers 5,7 could be moveable (for example themselves mounted on moving vehicles) in which case the calculations would be adapted according to the changing position coordinates of the object trackers 5,7 but otherwise the approach is the same. Such an arrangement might remove the need for larger multiples or arrays of object trackers covering a larger area.

Note that the positions of the object trackers 5,7 can be predetermined or known, but can instead be measured, for example by providing each with a GPS device. While it is desirable to avoid the need for expensive GPS trackers, this is primarily concerned with the object to be tracked itself and accurate determination of the positions of the object trackers 5,7 (for example if they are moving) may be important. Alternatively, or additionally, each object tracker can be adapted to determine its position by measuring radio signals from base stations in the vicinity of the object tracker, for example employing a cellular network-based positioning system.

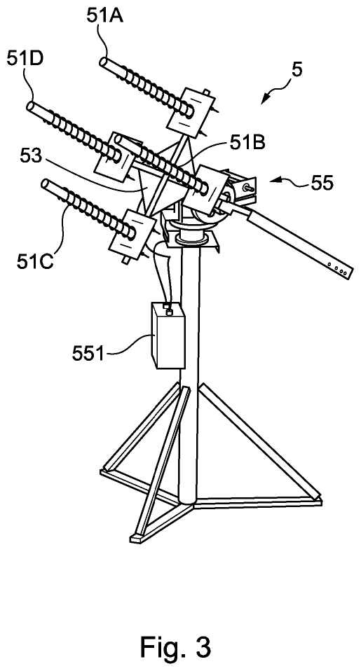

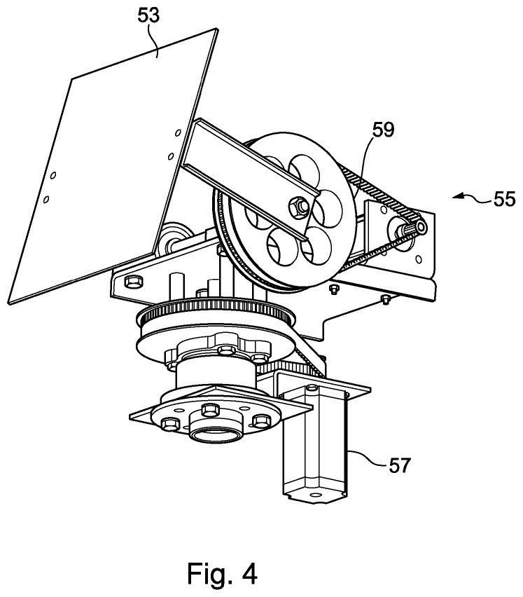

More detail of the object tracker 5 is shown in FIG. 3 (object tracker 7 is identical in this embodiment and is therefore not described separately). The object tracker 5 comprises four antennas 51A, 51B, 51C and 51D, which are arranged in two opposing pairs 51A&C and 51B&D. The antennas 51A, 51B, 51C and 51D are directional and are fixed in relation to one another. FIG. 4 shows a pan and tilt unit 53 which enables a base plate 55 to which the antennas are mounted (normal to the base plate 55 as shown in FIG. 3) to be panned and tilted and thereby control the direction in which the antennas 51A, 51B, 51C and 51D are pointed.

In order to determine the azimuth and elevation of the object 3 relative to the object tracker 5, as well as continuously track the object 3 as it moves, it is desirable to automatically point the object tracker 5 at the object 3. In this embodiment this is achieved by comparing the phases of the signals received by each of the antennas of a particular pair 51A&C or 51B&D. Because the distance to the object 3 is much greater than the distance between the antennas of a particular pair, the amplitude of the signal reaching the antennas can be assumed to be equal. Accordingly, any phase difference can be attributed to an angular offset between the direction in which the antennas 51A, 51B, 51C and 51D are pointed and the source of the signal 31, i.e., the object 3 being tracked.

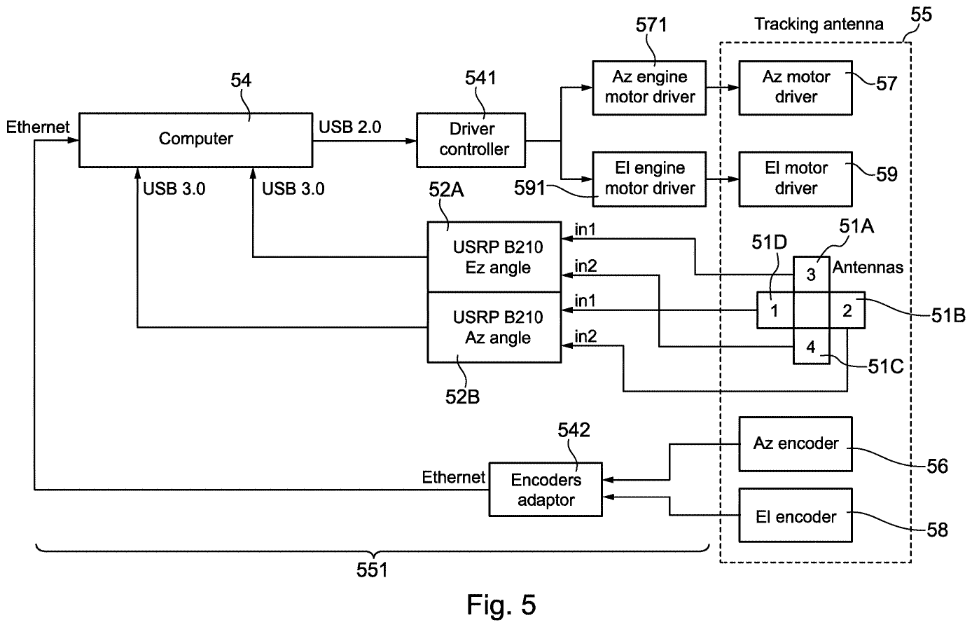

Tracking is performed along two orthogonal channels, namely in the azimuthal (i.e., horizontal) and elevation (i.e., vertical) planes, by comparing the signal received by respective pairs 51A&C and 51B&D of antennas. As illustrated in FIG. 5, for each channel, a receiver 52A,52B receives a signal from the respective two antennas 51A&C, 51B&D, digitizes it and sends it to a processor 54 (in this case a suitably programmed computer) for processing. The processor calculates the phase difference between the signals from each antenna in each pair 51A&C and 51B&D and, using a controller 541 (in this case a PID controller), calculates a control signal for each motor drive 57,59 (see FIG. 4) which is sent to each motor drive 57,59 by a respective drive 571,591. When the phase difference is zero, the corresponding control signal is also zero and the antenna remains stationary and aimed at the signal source (i.e., the object).

When the object 3 is displaced, a path difference arises which as intimated above gives rise to a non-zero phase difference between the respective signals. The processor 54 re-calculates the control signal(s) such that the motor drive(s) 57,59 turns the antennas 51A, 51B, 51C and 51D towards the displaced object 3 and restores the phase difference to zero. Thus, the object tracker 5 (and specifically the antennas 51A, 51B, 51C and 51D) are continuously pointed at the source of the signal 31, i.e., the object 3 being tracked. This is performed, simultaneously, for the azimuthal and elevation orientations. The direction in which the antennas are pointed, which in this embodiment is measured by respective azimuth and elevation encoders 56,58 and communicated to the processor 54 via encoder adapter 542, provides the system with the respective azimuths and elevation angles for all the object trackers 55 which is then used to determine the object position as described in detail above.

The signal processing and analysis etc. (including the phase difference determination) carried out within the section indicated by reference numeral 551 in FIG. 5 may be performed in a dedicated unit (also indicated by reference numeral 551 in FIG. 4) associated with the object tracker 5. Each object tracker 5,7 can be provided with such a unit. A particular unit may also receive the encoded azimuth and elevation data not only for the associated object tracker but from the or another object tracker, in which case the processor 54 might also calculate the position of the object based on its own and the received azimuth and elevation data.

The above describes a preferred approach to object tracking but it will be understood that other approaches may be possible relying on other methodologies; what is important is that the object trackers 5,7 are able to each determine an azimuth and an elevation from which the object position can be determined. For example, for further accuracy several pairs of antennas may be provided and/or instead of pairs of antennas linear arrays of multiple antennas may be employed, for example three or more in a horizontal array and three or more in a vertical array. In certain embodiments one or more antennas may be shared between different array (for example in a 3×3 array the signal detected by the central antenna may provide a signal to the azimuth and the elevation determination process). It is also foreseen that instead of using the phase difference to orient the antennas the phase difference itself might be used to determine a relative direction to the object; the phase difference being proportional or at least related to the separation between the antennas (which is fixed) and the angular offset to the object with respect to both antennas. Local direction determination might also be determined by local triangulation based on relative signal strengths at the antennas. Combinations of these techniques might also be used, and different object trackers might use different techniques.

It will also be understood that if the object is moving it may not be possible to achieve a zero phase difference in one or both channels, in which case the processor and/or controller may be configured to minimise the phase difference or indeed maintain a predetermined or selected constant phase difference.

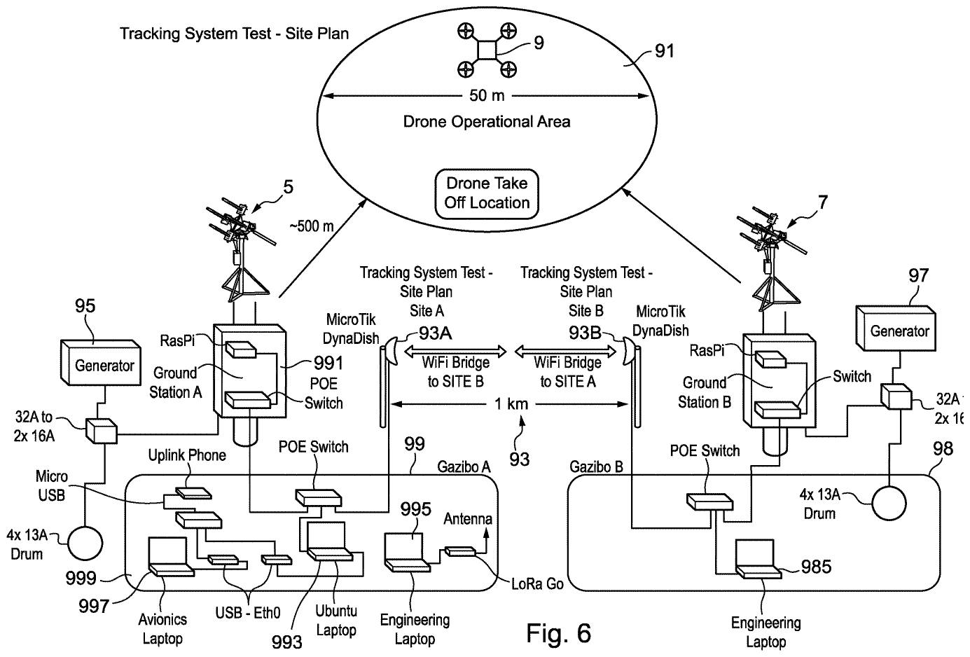

To calibrate the system the transmitter for the object 3 (or a like transmitter) may be mounted on or in a drone 9 (or other aerial vehicle, manned or unmanned) and flown within a test area 91 observed by both (or any or all as intimated above) object trackers 5,7. FIG. 6 illustrates further detail of an object tracking system employing two object trackers 5,7, in this case during such a calibration process though the same system can be used for object tracking. The drone 9 may be provided with a high accuracy GPS device 9 (aerospace standard) in order to provide high accuracy and high precision position information against which to calibrate the position information determined via the object trackers as described in detail above. It is foreseen that the position of the drone 9 (or other aerial vehicle, manned or unmanned, as the case may be) against which the system is to be calibrated can be determined using any suitable or reliable position determination system (including ranging systems such as radar). While calibration may be performed on a single measurement it is more appropriate to fly the drone around the test area to generate a sequence of position information (from the system 1 and the calibration system) on which to perform the calibration.

As shown in FIG. 6, determination of the position of an object (during calibration said object is the drone 9) may be carried out at one location 99 which receives azimuth and elevation data from both object trackers 5,7. In this embodiment the object position determination is carried out proximate to one of the object trackers 5 but in other embodiments it may take place remote from both object trackers 5,7. In this embodiment there is a long distance wireless communication bridge 93 between both object tracker sites 98,99, facilitated by wireless ethernet antennas 93A,93B, but again communication can be achieved in any practical and/or known manner. Communication in this way May be used to time-synchronise the measured azimuth and elevation data from the object trackers 5,7; alternatively, a central controller or the like may provide a time synchronisation signal to each object tracker by which the measured azimuth and elevation data can be time-stamped to ensure the position is being determined from data which originated from the object trackers at the same time. In such examples it may not be necessary to provide a communication link directly between object trackers.

The object trackers may be powered by generators 95,97 (as shown in FIG. 6) or in any other practical or known manner, such as storage batteries and/or mains power supply. Power over Ethernet (POE) may be employed to power processors and/or controllers along the same lines used to communicate data, isolated from separate and relatively noisy power supplies (such as the aforementioned generators, storage batteries and/or mains supply) which may be used to drive the pan and tilt mechanisms of the object trackers 5,7.

In the system shown in FIG. 6, and as noted above, the object position determination is carried out at location 99. Here there is located a ground station 991 which receives data from the object trackers 5,7 and communicates this to a first computer 993 which determines the position of the object (drone 9). A second computer 995 is provided for engineering purposes (similar 985 provided at the second object tracker location 98), and a third computer 997 is provided for avionics purposes. The first and second computers 993, 997 are connected to an uplink for communication to one or other remote sites which may require the object position data.

In addition to the benefits noted above, such as eliminating the need for expensive radar installations and/or GPS receivers (though these might be used for initial, occasional or periodic calibration purposes), it is foreseen that the invention may be used to supplement or indeed provide back-up or fail-safe options in case those more sophisticated methods fail. However, the Applicant is primarily concerned with lowering the bar to entry to the small space industry, and the invention provides an affordable yet importantly reliable way of tracking objects such as launch vehicles. It is also foreseen that the system can be adapted to detect signals from transmitters which are already present in launch vehicles (and the like) for other purposes. It will be enough to know at what frequency the transmitter is transmitting as the data being transmitted is irrelevant for these purposes; all that is required is a signal that can be detected by the object trackers. In other words, the primary purpose of the transmitter which is used for tracking the object need not be for said tracking. For example, it might be a transmitter for data; that said, the data might include telemetry data (in which case the present system might be a backup to on-board telemetry).

While the system does require at least two object trackers, compared to radar installations which can make use of one antenna, it can be thought of as being a passive mode of object tracking. By way of explanation, unlike radar the object trackers do not emit or transmit a signal to be detected after reflection from the object. The object trackers therefore operate stealthily and without interference. It is to be expected that such systems will not require licenses or permits to use, unlike radar or other similar ranging technologies.

Also, methods described herein require the antennas to be continuously pointed at the object to be tracked. This is not possible, at small or portable scale at least, with conventional ranging methodologies whereas the phase difference zeroing/minimising approach described above means that simple antennas will suffice; in turn such simple antennas can be very light and therefore it is easy to create object trackers and systems which allow them to be moved (direction and/or position) to so track objects of interest.

The invention provides a relatively simple and cost-effective way of determining the position of an object, such as a launch vehicle, without the need for expensive radar installations or GPS receivers. A transmitter is mounted on or in the object and the signal transmitted thereby from the object is detected by two or more object trackers on the ground. The object trackers determine the azimuth and elevation angles to the object relative to the object trackers. This can be achieved by automatically pointing the object trackers at the object, tracking the object as it moves, and recording the azimuth and elevation angles at which the object trackers are pointed. Based on the known coordinates of the object trackers, which may themselves be moved or moving, the position of the object can be determined from the determined azimuth and elevation angles. There is also described a way of achieving the automatic tracking, by minimising the phase difference between the signal detected by closely spaced pairs of antennas.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

For example, the invention has been exemplified with reference to tracking of launch vehicles; the skilled person will realise that the invention may also be used to track other airborne or moving (or indeed stationary) objects and provide the same or similar advantages.

1. A system for determining the position of an object, the system comprising:
a transmitter for locating on or in the object and configured to transmit a signal; and a plurality of object trackers;
wherein a first of the object tracker is configured to detect the signal and determine a first azimuth angle and a first elevation angle to the transmitter;
wherein a second of the object tracker is configured to detect the signal and determine a second azimuth angle and a second elevation angle to the transmitter; wherein the system is configured to determine the position of the transmitter based on the first and second azimuth angles, the first and second elevation angles, and the respective positions of the object trackers; and
wherein each object tracker comprises a plurality of antennas and is configured to determine the azimuth angle and elevation angle to the transmitter by automatically pointing the object tracker in the direction of the transmitter.

2. The system of claim 1, wherein at least one object tracker is configured to track the azimuth angle and elevation angle to the transmitter at each position as the object moves.

3. The system of claim 1, wherein at least one object tracker comprises at least two pairs of antennas, arranged in orthogonal planes corresponding to the azimuthal and elevation planes.

4. The system of claim 3, wherein at least one object tracker is configured to determine a phase difference between the signal as received at the antennas of each pair of antennas, and to minimize the phase difference so as to automatically point the object tracker in the direction of the transmitter.

5. (canceled)

6. (canceled)

7. The system of claim 1, wherein the transmitter is configured to transmit an omnidirectional signal.

8. The system of claim 1, wherein each object tracker comprises an azimuth motor and an elevation motor to control the azimuth angle and the elevation angle of the antennas.

9. The system of claim 1, wherein each object tracker comprises two pairs of antennas and a corresponding pair of encoders, wherein each object tracker is configured to control the azimuth angle and the elevation angle to minimize the phase difference between the detected signals, and the encoders are configured to determine the azimuth and elevation angles at which the object tracker is pointed when the phase difference is minimized.

10. The system of claim 7, wherein each object tracker comprises an azimuth motor and an elevation motor to control the azimuth angle and the elevation angle of the antennas.

11. (canceled)

12. (canceled)

13. The system of claim 1, wherein one or more of the object trackers are mounted on a vehicle.

14. (canceled)

15. The system of claim 1, wherein the transmitter is a software defined radio (SDR) transmitter.

16. A method of determining the position of an object, the method comprising:
providing first object tracker at a first position;
providing a second object tracker at a second position;
using the first object tracker to detect a signal from the object at the first position and determining a first azimuth angle and a first elevation angle to the object;
using the second object tracker to detect the signal from the object at the second position and determining a second azimuth angle and a second elevation angle to the object; and
determining the position of the object based on the first and second azimuth angles, the first and second elevation angles, and the first and second positions;
wherein each object tracker comprises a plurality of antennas and determines the azimuth angle and elevation angle to the object by automatically pointing the object tracker in the direction of the object.

17. The method of claim 11, comprising locating a transmitter on or in the object to transmit the signal.

18. The method of claim 11, comprising tracking the azimuth angle and elevation angle to the transmitter at each position as the object moves.

19. The method claim 11, wherein each object tracker comprises a plurality of antennas and automatically pointing each object tracker in the direction of the object comprises automatically pointing the antennas of each object tracker in the direction of the object.

20. The method of claim 11, comprising determining a phase difference between the signal received at a first antenna and the signal received at a second antenna, and changing the direction in which the antennas are pointing to minimize the phase difference so as to automatically point the object tracker in the direction of the object.

21. (canceled)

22. The method of claim 15, wherein the method comprises controlling and/or measuring the azimuth angle and the elevation angle of the antennas.

23. The method of claim 11, wherein the method comprises determining a relative direction to the transmitter based on an amplitude difference between two antennas.

24. The method of claim 11, wherein the method comprises automatically pointing two pairs of antennas at the object and determining the azimuth and elevation angles at which the pairs of antennas are pointed using corresponding azimuth and elevation encoders.

25. The method of claim 11, wherein the method comprises fixing at least one of the object trackers in position.

26. The method of claim 11, wherein the method comprises mounting at least one of the object trackers on a vehicle and moving the vehicle.

27. (canceled)

28. (canceled)

29. (canceled)

30. (canceled)

31. (canceled)

32. (canceled)
